(19) United States
(12) Patent Application Publication
(10) Pub. No.: US 2012/0308319 A1
(43) Pub. Date: Dec. 6, 2012

(54) ROTARY CUTTING TOOL HAVING COATED CUTTING TIP AND COOLANT HOLES AND METHOD OF FABRICATING

(76) Inventors: Karthik Sampath, Pittsburgh, PA (US); Armin Josef Zimmermann, Oberviechtach (DE)

(21) Appl. No.: 13/152,389

(22) Filed: Jun. 3, 2011

(51) Int. Cl. B23B 51/06; B23P 15/32; B23B 51/02

(52) U.S. Cl. 408/59; 408/199; 408/145; 76/108.6

(57) ABSTRACT

A cutting tool for performing hole-cutting operations on a workpiece when the cutting tool is rotated about a central longitudinal axis. The cutting tool includes a generally cylindrical body having a first end structured to engage the workpiece and an opposite second end structured to be mounted to a machine tool; a groove formed in the first end of the generally cylindrical body, the groove disposed generally transverse to the longitudinal axis; and a nib portion disposed in, and coupled to, the groove via a brazing process.

### BACKGROUND

1. Field of the Invention

The invention relates generally to rotary cutting tools and, more particularly, to cutting tools, such as drills, having cutting tips coated with a secondary material, such as polycrystalline-diamond (PCD). The invention further relates to a method for forming such cutting tools.

2. Background Information

Polycrystalline-diamond (PCD) drills have historically been formed as straight fluted, facet point drills. More recently, veined PCD drills have been formed having helical flutes and more complex point geometries similar to solid carbide drills. One of the major uses of such highly engineered PCD drills is for drilling in composite materials, such as carbon fiber reinforced polymer (CFRP) titanium composites.

Drilling in titanium requires good coolant flow within the drill to control the heat generated during drilling. Veined PCD drills are commonly fabricated as a PCD tip portion and rod which are later brazed together and preferably include through-coolant holes breaking out in the tip. Typically, such coolant holes are formed in the PCD tip portion via an EDM process (electric discharge machining) that is carried out after the tip portion has been brazed to the rod. Such EDM process is typically quite expensive due to necessary set-up and processing times. Additionally, known veined PCD drills commonly utilize a central coolant hole through the core of the drill which feeds the coolant holes formed in the tip portion via EDM. The presence of such a central coolant hole generally reduces the strength, and thus the durability of the drill, a critical aspect for drills used to drill titanium materials.

There is, therefore, room for improvement in cutting tools used for drilling CFRP-titanium and other similar materials.

### SUMMARY OF THE INVENTION

Such deficiencies in the prior art are addressed by embodiments of the invention which are directed to an improved rotary cutting tool and a method of making such a cutting tool.

As one aspect of the invention, a cutting tool for performing hole-cutting operations on a workpiece when the cutting tool is rotated about a central longitudinal axis is provided. The cutting tool comprises: a generally cylindrical body having a first end structured to engage the workpiece and an opposite second end structured to be mounted to a machine tool; a groove formed in the first end of the generally cylindrical body, the groove disposed generally transverse to the longitudinal axis; and a nib portion disposed in, and coupled to, the groove via a brazing process.

The generally cylindrical body may comprise a number of coolant passages formed therein, each coolant passage of the number of coolant passages extending from a first opening formed in the first end of the generally cylindrical body adjacent the groove to a second opening formed in the second end of the generally cylindrical body.

The nib may comprise a base portion formed from a first material and a coating portion formed from a second material deposited on the first material.

The first material may comprise a carbide material and the second material may comprise a PCD material.

The second material may comprise a number of cutting edges formed therein.

As another aspect of the invention, a method of forming a cutting tool is provided. The method comprises providing a nib comprising a base portion formed from a first material and a coating portion formed from a second material deposited on the first material. A nib is brazed into a groove formed in a first end of a generally cylindrical rod member to form a cutting tool assembly. The generally cylindrical rod member includes a number of coolant passages formed therein, each coolant passage of the number of coolant passages extends from a first opening formed in a second end of the generally cylindrical body opposite the first end to a second opening formed in the first end of the generally cylindrical body adjacent the groove.

The method may further comprise forming a number of flutes in the cutting tool assembly and forming a cutting point from a portion of the nib and the first end of the generally cylindrical body. Forming a cutting point may comprise forming a number of cutting edges in the second material. Forming a number of cutting edges may comprise grinding a number of cutting edges in the second material. The second material may comprises a PCD material.

### BRIEF DESCRIPTION OF THE DRAWINGS

A full understanding of the invention can be gained from the following description of the preferred embodiments when read in conjunction with the accompanying drawings in which:

FIG. 1 is an elevational side view of a cutting tool in accordance with an example embodiment of the present invention;

FIG. 2 is an isometric view of a portion of the cutting tool of FIG. 1;

FIG. 3 is an elevational detail view of a portion of the cutting tool of FIG. 1; and

FIG. 4 is an exploded elevational side view of the cutting tool of FIG. 1.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein. Identical parts are provided with the same reference number in all drawings.

As used herein, the term “number” shall be used to refer to any non-zero quantity (i.e., one or any quantity greater than one).

As used herein, the term “about” shall be used to refer to a location generally near, or at, a particular identified point (i.e., proximate).

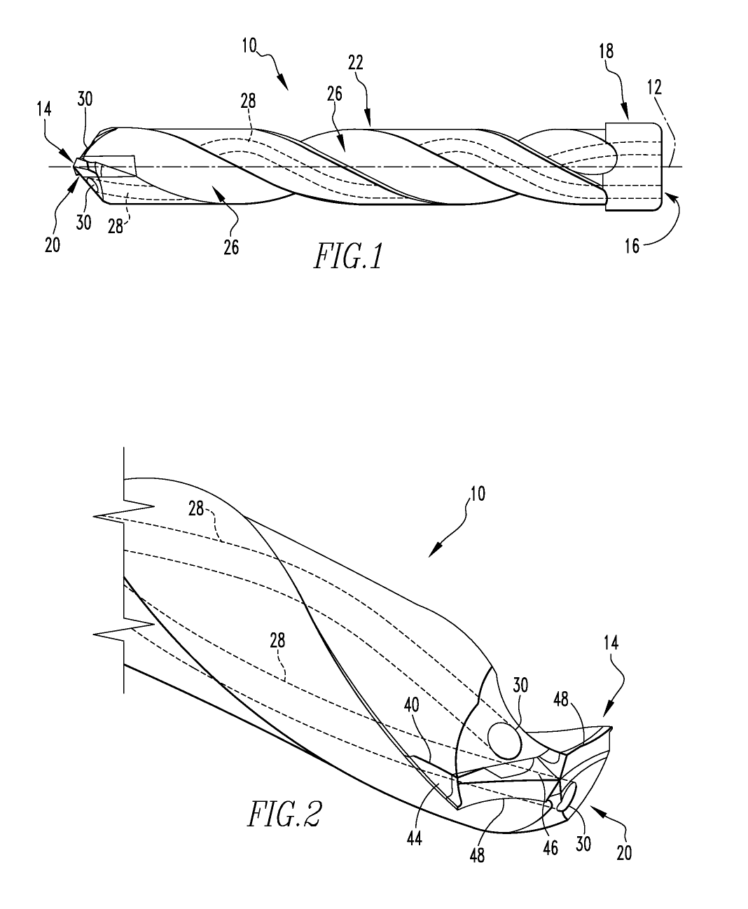

FIGS. 1-4 depict various views of an example cutting tool 10, in accordance with a non-limiting embodiment of the present invention, for conducting cutting operations on a workpiece (not shown) when cutting tool 10 is rotated about a central longitudinal axis 12. Although depicted as a drill in the exemplary embodiment described herein, it is to be appreciated that concepts described herein are applicable to other cutting tools such as, for example, without limitation, mills, reamers, or other rotary cutting tools that employ brazed tips.

Cutting tool 10 includes a first end 14 and an opposite second end 16. Cutting tool 10 further includes a mounting portion 18 disposed at or about the first end 14 for mounting the cutting tool 10 in a chuck mechanism of a machine tool (not shown), a cutting tip 20 disposed generally at second end 16 for engaging and cutting a workpiece (not shown), and a body portion 22 of generally cylindrical shape disposed between the mounting portion 18 and cutting tip 20. Preferably, body portion 22 is formed from carbide or other suitable hardened material.

The cutting tool 10 further includes a number of flutes 26 (two in the illustrated example) as well as a number of coolant passages 28 defined in the generally cylindrical body 22. As shown in the illustrated embodiment, the number of flutes 26 and coolant passages 28 are preferably oriented in a helical fashion about the central longitudinal axis 12. However, it is to be appreciated that the number of flutes 26 and coolant passages 28 may also have a varying or straight orientation without varying from the scope of the present invention. Regardless of the selected orientation, it is to be readily appreciated that each coolant passage 28 runs generally parallel alongside a corresponding flute 26. As shown in FIGS. 1 and 4, each coolant passage 28 extends along the generally cylindrical body from a first opening 30 formed in the first end 14 of the cutting tool 10 to a second opening 32 formed in the second end 16, and thus the cutting tip 20, of the cutting tool 10.

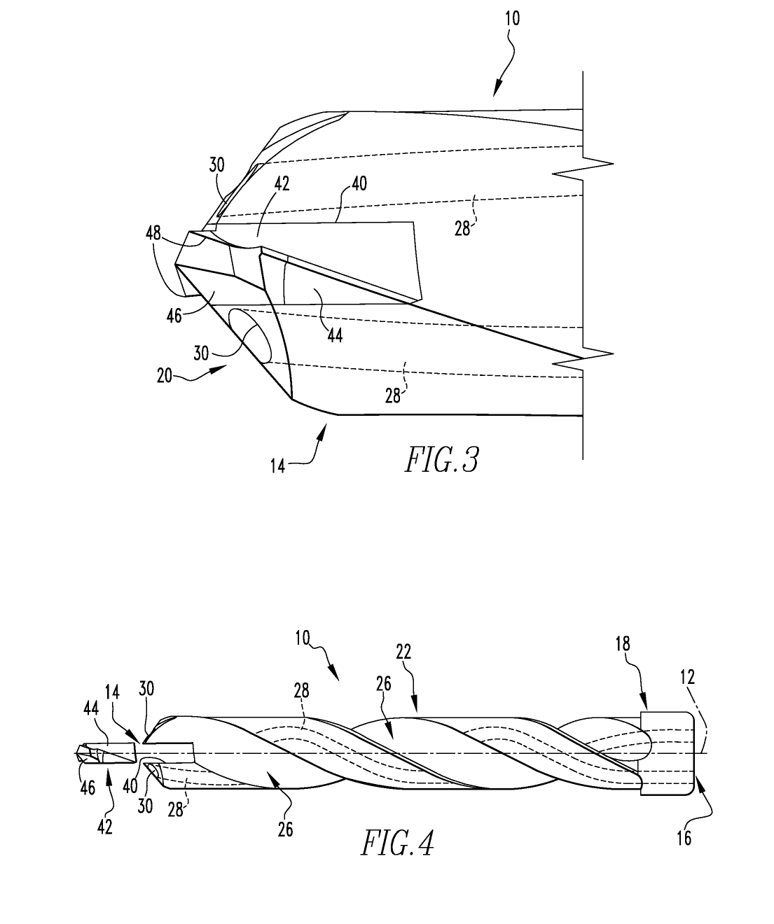

Referring to FIG. 4, the cylindrical body 22 includes a groove 40 formed in the first end 14 adjacent the first openings 30 of each of the number of coolant passages 28 and oriented generally transverse to the central longitudinal axis 12. Groove 40 is sufficiently sized and configured to receive a nib 42 therein which is rigidly coupled to the cylindrical body 22, preferably via a brazing process, such as those commonly known in the art. As shown in the detail view of FIG. 3, nib 42 includes a base portion 44 formed from a first material and a coating portion 46 formed from a second material deposited in the first material. A number of cutting edges 48 (two in the illustrated example) are formed in the second material. Preferably, the base portion 44 is formed from a carbide or other suitable material that can be coupled to the cylindrical body through brazing or other suitable process. Coating portion 46 is preferably formed from PCD but may also be formed from another suitable material.

From the previous description, a person of ordinary skill in the art would readily appreciate that there are a number of ways that a cutting tool 10 according to the present invention may be formed. As an example, a cutting tool 10 according to the present invention may be formed by starting with a rod, such as generally cylindrical body 22, having coolant passages 28 and/or coolant passages 28 and flutes 26 formed therein. A groove 40 may be preformed into such rod, ground therein, or produced via EDM. Next, a nib 42, precoated with the desired hardened material 46, would then be coupled in, and to, the groove via a suitable process (e.g., without limitation, brazing). Finally, the desired finished cutting tip 20 is then produced via grinding, EDM, laser, or other suitable process such that all cutting edges 48 are formed by the hardened material 46, while the coolant passages break out through the material of the cylindrical body 22 rearward on the cutting tip from the hardened material 46.

From the non-limiting exemplary embodiment described herein, it is to be appreciated that the present invention provides a drill having a cutting tip having hardened PCD (or similar material) cutting edges along with coolant holes provided thereby without requiring and EDM processing.

It is also to be appreciated that the present invention provides a number of other benefits over known PCD drills. Such benefits include, for example, without limitation, the ability to use existing coolant hole rods in manufacturing PCD drills and does not require a central coolant hole (thus stronger).

While a specific embodiment of the invention has been described in detail, it will be appreciated by those skilled in the art that various modifications and alternatives to the details provided herein could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A cutting tool for performing hole-cutting operations on a workpiece when the cutting tool is rotated about a central longitudinal axis, the cutting tool comprising:
a generally cylindrical body having a first end structured to engage the workpiece and an opposite second end structured to be mounted to a machine tool;
a groove formed in the first end of the generally cylindrical body, the groove disposed generally transverse to the longitudinal axis; and
a nib portion disposed in, and coupled to, the groove via a brazing process.

2. The rotary cutting tool of claim 1 wherein the generally cylindrical body comprises a number of coolant passages formed therein, each coolant passage of the number of coolant passages extending from a first opening formed in the first end of the generally cylindrical body adjacent the groove to a second opening formed in the second end of the generally cylindrical body.

3. The rotary cutting tool of claim 1 wherein the nib comprises a base portion formed from a first material and a coating portion formed from a second material deposited on the first material.

4. The rotary cutting tool of claim 3 wherein the first material comprises a carbide material and the second material comprises a PCD material.

5. The rotary cutting tool of claim 4 wherein the second material comprises a number of cutting edges formed therein.

6. A method of forming a cutting tool, the method comprising:
providing a nib comprising a base portion formed from a first material and a coating portion formed from a second material deposited on the first material;
brazing the nib into a groove formed in a first end of a generally cylindrical rod member to form a cutting tool assembly, the generally cylindrical rod member having a number of coolant passages formed therein, each coolant passage of the number of coolant passages extending from a first opening formed in a second end of the generally cylindrical body opposite the first end to a second opening formed in the first end of the generally cylindrical body adjacent the groove.

7. The method of claim 6 further comprising:
forming a number of flutes in the cutting tool assembly; and
forming a cutting point from a portion of the nib and the first end of the generally cylindrical body.

8. The method of claim 7 wherein forming a cutting point comprises forming a number of cutting edges in the second material.

9. The method of claim 8 wherein forming a number of cutting edges comprises grinding a number of cutting edges in the second material.

10. The method of claim 9 wherein the second material comprises a PCD material.
